(19) United States
(12) Patent Application Publication
(10) Pub. No.: US 2026/0262611 A1
(43) Pub. Date: Sep. 10, 2026

(54) A DARK BROODER

(71) Applicant: SALLY FARMS LIMITED, Penrith (GB)

(72) Inventor: Leon FURLONG, Penrith (GB)

(21) Appl. No.: 18/843,086

(22) PCT Filed: Feb. 27, 2023
(86) PCT No.: PCT/GB2023/050438

§ 371 Date: Aug. 30, 2024

(30) Foreign Application Priority Data
Mar. 1, 2022 (GB) 2202816.1

(51) Int. Cl. A01K 31/19; A01K 31/20

(52) U.S. Cl. CPC A01K 31/19; A01K 31/20

(57) ABSTRACT

A dark brooder comprising a metal frame to which a plurality of wall portions is connected. The frame is further provided with a readily removable lid section.

### FIELD OF THE INVENTION

The invention relates to a dark brooder, particularly for use in rearing young chicks in the poultry environment.

### BACKGROUND TO THE INVENTION

It has been observed that poultry, particularly chickens are healthiest when bred in the wild, rather than being intensively farmed. When chicks are born in the wild, they spend around 65% of their time resting under their mother's wing, in the dark, spending the other 35% of their time foraging, with all of the chicks sleeping together and foraging together, which is known as synchronicity of their behaviour.

In commercial settings, on average, chicks are in a poultry shed on a farm over 26 hours after hatching. In such circumstances, the natural process of imprinting, whereby the bird understands where they live and who their mother is, has been lost. The crucial time of imprinting is between 13 and 16 hours after hatching. In the hatching process and when placed on the farm, chicks are exposed to substantially continuous light. During that time of continuous light, the chicks miss out on the crucial 13 to 16 hour “imprinting period”, and so they lose the natural synchronistic pattern of behaviour that they would naturally learn, during which they develop the aforementioned synchronicity of behaviour. Thus, some chicks will feed whilst others sleep, which becomes a stressful environment for the birds. Furthermore, the active birds often start to peck at the sleeping birds due to misdirected foraging and pecking behaviour.

As the birds develop, the pecking continues and the pecking behaviour learned in the early stages of life continues and often causes injurious pecking in adulthood, wherein 90% of chicks that peck resting birds at 4 weeks old peck at other birds in adult life and cause injury.

It has been shown that by using a ‘dark brooder’, which simulates the dark and warmth of a mother hen, can significantly reduce injurious pecking behaviour by over 80%. Dark brooders are generally dark places in which birds that wish to rest can shelter and they may be provided with a heater. Typically, these are fabricated from wooden sheets connected to one another with electric tube heaters underneath or with heat lamps within the structure. Where heat lamps are employed the light level within the brooder is increased, thereby reducing the effectiveness of the dark brooder because it is no longer dark therein. It is also known to use horizontal heating elements with curtains around the periphery of at least one side of the wooden structure.

It has been found that active birds will not commonly enter a dark brooder, thereby reducing the risk of the active chicks pecking the sleeping chicks. As a result, dark brooders are known to assist with establishing synchronicity within a poultry house.

Many dark brooders are large structures that have a small surface area to volume ratio, which is to say that the periphery of the structure is relatively small for its volume. This creates a problem due to reduced airflow and areas of heat due to a lack of air flow, along with a lack of access for inspecting the internal volume of the brooder. Furthermore, because of the small periphery for the size of the brooder, entrances and exits may become restricted or blocked due to sleeping birds, thereby creating a problem for birds wishing to enter or leave the brooder and increasing the risk of smothering, which can lead to death. Additionally, as the water and feeding stations in a poultry house are at set distances apart, the use of large dark brooders can block access to food and water.

### SUMMARY OF THE INVENTION

Accordingly, the present invention is directed to a dark brooder comprising a metal frame to which a plurality of removable wall portions is connected, and wherein the frame is provided with a readily removable lid section.

Thus, the present invention has a frame structure to which wall portions can be connected around the periphery thereof and upon which a lid section is applied. The readily removable lid section allows for easy inspection of the inside of the dark brooder and also allows for easy cleaning of the internal parts of the dark brooder. The lid section may comprise plastics material, which is at least translucent and, advantageously opaque, or, the lid section is more preferably, a metallic material, such as aluminium or steel.

The dark brooder of the present invention provides a shelter that is attractive to young chicks and provides warmth and shade to give a comforting place to rest. The provision of the removable lid section and the plurality of removable wall portions allows the dark brooder to be flexible in how it is used. For example, as the chicks grow, the wall portions can be removed from the frame after four to six weeks, if the chicks no longer require the dark brooder; however, leaving the frame in place reduces the time required to clean and prepare a poultry house for a new population, because the walls portions and lid can be quickly put back in place, after cleaning, ready for the new chicks. Thus, the frame may be kept in place whilst the wall portions and/or the lid section are removed.

Preferably, a removable plastics material slat section is placed on top of the lid section. The addition of a slat section on top of the lid reduces the likelihood of the lid section being displaced by the poultry thereunder. Additionally, it further provides the birds a more comfortable surface on which to grip, whilst also protecting the lid section from being scratched by the feet of the poultry. It will be appreciated that the plastics material slat section also provides insulation to the lid section to reduce heat loss therefrom, thereby making the device more efficient and keeping the bird warm.

It is particularly advantageous that the lid section and the plastics section fit to the frame without any lips and gaps forming, particularly on the uppermost surface. This can assist in avoiding the risk of food or other items becoming trapped within the structure of the dark brooder, which, for example, can happen where spin-feeding is employed. Thus, the lid section and the plastics material slat section can be provided with lips or flanges that extend over the top of the frame.

Advantageously, at least one of the plurality of wall portions is provided with a magnetic connector adjacent an intended top edge for connecting the wall portion to the frame. The use of a magnetic connector on the, or each, wall portion, which is optimally positioned at, or adjacent the intended top of the wall portion, provides a quick and efficient way for the wall portions to be attached to, and detached from, the metal frame. The wall portions are able to stick to the metal frame, thereby ensuring a good connection to the frame, whilst also being quick and easy to install.

The magnetic portions may be provided with a locating element, for example a protrusion, with a recess in the frame to allow accurate location of the wall portions. Clearly, the protrusion and recess may be reversed so that the protrusion is on the frame and the recess in the wall portion. The frame may be dimensioned to allow for the wall portion to be positioned at different heights on the frame. Thus, the size of the frame to which the wall portion is connected may be greater than the size of the magnetic connector on the wall portion, thereby allowing for the wall portion to be attached at varying positions, or heights. To that end, the frame may be provided with predetermined slots or steps to allow the wall portions to be connected at predetermined positions.

It will be appreciated that the lid section may also be provided with at least one magnetic connector to hold it in place.

In a preferred arrangement, at least one of the wall portions comprises a flexible plastics material having slits therein to create flaps and, more preferably, the flaps are between 2 cm and 10 cm in width. The width of the flaps may be adjusted to take into account the breed of the birds, the activity thereof and the air flow required for the internal section of the dark brooder. The use of wall portions that can be readily removed from the metal frame allows for the quick and easy substitution of wall portions where the type of birds populating the poultry house is changed. The structure of the wall portions, with flaps, allows for air flow but also reduces the windchill within the dark brooder.

The use of a flexible plastics material, for example, polyvinylchloride, allows for quick removal and/or replacement of the wall portions and the flaps create a curtain arrangement around the periphery of the dark brooder. Additionally, the wall portions, once removed, can be submerged in in appropriate cleaning fluid before being rinsed.

The flexible plastics material reduces the risk of mechanical damage to the wall portion during the cleaning process and can be chosen to avoid chemical damage. Alternatively, the wall portion can be cleaned in-situ using a spray and/or steam cleaning system.

In one arrangement, the height of the position of the wall portions on the frame can be adjusted to provide a gap therebeneath of between 1 cm and 6 cm. The ability to adjust the height of the wall portions with respect to the litter on the floor of the poultry house allows for the dark brooder to be adapted to the different poultry and chick behaviour.

Additionally, the height adjustable wall portions all for variations in airflow within the dark brooder. By positioning the wall portion and/or flaps thereof higher up the frame the gap therebeneath can be increased to allow more air into the dark brooder. Similarly, if more warmth is required within the dark brooder, the wall portions can be positioned lower down to retain heat therein.

The length of the wall portions, or curtain, may require adjustment depending upon the litter used in the poultry house and/or the breed of poultry.

It is particularly advantageous that the lid section comprises a conductive material and an infra-red heater is provided that can heat the lid section. The provision of an infrared heater that is positioned to heat the lid section removes the need to place the heater within the dark brooder itself. In turn, this allows for more even heating of the dark brooder because the heat is spread over a larger area, rather than being focused on a particular spot within the volume of the dark brooder. Furthermore, the heater can be readily serviced without deconstructing the dark brooder. The heater may be controlled manually, if required, or it may be automated.

The infrared heater of the present invention, combined with a conductive lid section, creates a radiator that removes the need for a heater underneath the brooder, although it will be appreciated that other heating apparatus may be employed in addition to the infrared heater, for example, under-litter heating. A thermostat may be incorporated into the dark brooder in order to monitor the temperate therein, which may be connected to the heater in order to automatically operate the heater. The use of a plastics material slat section on top of the lid section provides a layer of insulation that reduces the risk of birds contacting the lid section and being burned.

The use of a dark brooder in accordance with the present invention allows for the synchronicity of the resting and feeding behaviour of the birds to be established, or re-established. This results in more relaxed birds and reduces stress levels in the poultry, thereby resulting in better growth, an enhanced immune system and less aggressive behaviour. In turn, less antibiotic use is required.

### BRIEF DESCRIPTION OF THE DRAWINGS

An embodiment of the invention will now be described, by way of example only, and with reference to the accompanying drawings, in which:

FIG. 1 shows a dark brooder in accordance with an embodiment of the present invention;

FIG. 2 shows an exploded view of the dark brooder of FIG. 1; and

FIG. 3 shows a view of a side panel used in the dark brooder of FIG. 1.

### DETAILED DESCRIPTION OF EXEMPLARY EMBODIMENTS

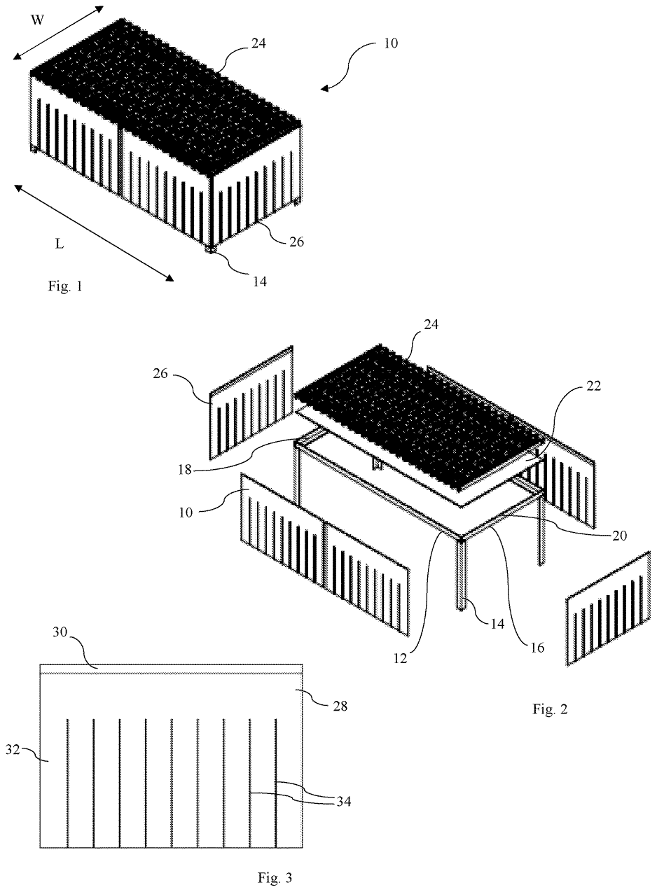

FIGS. 1 to 3 show a dark brooder device 10 comprising a metal frame 12 having legs 14 and a rectangular shaped top support 16 connecting the legs 14. The top support 16 of the frame 12 is provided with in internal, inwardly facing lip or flattened section 18 and the sides of the top support 16 have flat external surfaces 20.

A planar metal lid section 22 is provided that is sized to sit within the top support 16 and it rests upon the flattened section 18. A plastics material slat section 24 is arranged on top of the lid section 22 and is substantially the same size and shape, fitting within the top support 16.

Wall portions 26 are provided in the form of a top section 28 comprising a magnetic strip 30 and a flexible plastics material curtain 32 having slits 34 therein to create a plurality for strips extending from the top section 28.

To affix the wall portions 26 to the frame 12 of the dark brooder 10, the magnetic strip 30 of the wall portions 26 is affixed to the flat external surface 20 of the top section 16.

Thus, the wall portions 26 extend from the top section 16 downwardly towards the ground. Two wall portions 26 are employed for the long sides of the frame 12 and a single wall portion 26 is applied to the short sides of the frame 12. The wall portions 26 can be placed varying positions on the flat external surface 20 to adjust height of the ends of the wall portions 26 distal from the top section 28 thereof, thereby creating gap between the distal ends of the wall portions 26 and the ground. The gap can assist with air flow within the dark brooder 10 and the ease with which the strips of the wall portions 26 can be moved by the birds.

An infrared heater (not shown) can be placed adjacent the dark brooder 10 to heat the lid section 22, thereby creating a warm environment within the dark brooder 10.

Whilst dimensions can be varied, in the embodiment shown in the figures, the frame is dimensioned to be arranged between drinker lines and the length L is twice the width W, which allows for a wall portion 26 fit along the width W of the dark brooder 10 and for two of the same to be arranged along the length L of the dark brooder 10. This reduces the need to make different sizes and shapes of wall portion 26. In such an arrangement, there dark brooder 10 is small enough to fit between drinker lines that are set out at predetermined intervals. Additionally, having the length L being twice the width W provides a large perimeter to allow easy access for the birds, relative to the internal area. The height of the dark brooder 10 should be sufficient to allow air to flow therearound in order to ensure that areas of the dark brooder 10 are sufficiently ventilated whilst also retaining the warmth.

Where a metal frame is disclosed herein, the term may include a frame that is constructed from a non-metallic material but that comprises a metallic section in order to allow the magnetic element of the wall portions to attach thereto. Thus, it is envisaged that a plastics material frame may be employed in which a metallic section is incorporated to allow the wall portions to be magnetically connected thereto. A different connection mechanism could be employed, for example, a hook-and-eye arrangement or a slot and protrusion arrangement; however, a magnetic connection is considered to be the most efficient and easiest to use. Additionally, the magnetic arrangement is easier to clean than a hook-and-eye arrangement, thereby making the magnetic arrangement safer for the birds using the dark brooder.

The length of the flexible material of the wall portions may be adjustable within the wall portions themselves. For example, the wall portion may comprise a plurality of sections that can be rolled around a spindle and/or may be looped over a top bar to adjust their length, with either predetermined discrete fixings to shorten/lengthen the sections or a fixing that allows a continuous adjustment to any appropriate length.

In some arrangements, the wall portions and the lid section may be removed and, where employed, the plastics material slat section may be retained in place. This provides a welfare enhancement for the birds, particularly where the dark brooder is no longer required because the preferred behaviour patterns have been established. Thus, the frame can be kept in place in the poultry house and the plastics slat section retained thereupon. The flexible material of the wall portions is, preferably opaque; however, it will be appreciated that there may be situations in which a translucent material is employed.

1. A dark brooder comprising a metal frame to which a plurality of wall portions is connected, and wherein the frame is provided with a readily removable lid section.

2. A dark brooder according to claim 1, wherein a removable plastics material slat section is placed on top of the lid section.

3. A dark brooder according to claim wherein at least one of the plurality of wall portions is provided with a magnetic connector adjacent an intended top edge for connecting the wall portion to the frame.

4. A dark brooder according to claim 1, wherein at least one of the wall portions comprises a flexible plastics material having slits therein to create flaps.

5. A dark brooder according to claim 4, wherein the flaps are between 2 cm and 10 cm in width.

6. A dark brooder according to claim 1, wherein the relative height of the wall portions on the frame can be adjusted to provide a gap therebeneath of between 1 cm and 6 cm.

7. A dark brooder according to claim 1, wherein the lid section comprises a conductive material and an infra-red heater is provided that can heat the lid section.

8. A dark brooder according to claim 2, wherein at least one of the plurality of wall portions is provided with a magnetic connector adjacent an intended top edge for connecting the wall portion to the frame.

9. A dark brooder according to claim 2, wherein at least one of the wall portions comprises a flexible plastics material having slits therein to create flaps.

10. A dark brooder according to claim 3, wherein at least one of the wall portions comprises a flexible plastics material having slits therein to create flaps.

11. A dark brooder according to claim 2, wherein the relative height of the wall portions on the frame can be adjusted to provide a gap therebeneath of between 1 cm and 6 cm.

12. A dark brooder according to claim 3, wherein the relative height of the wall portions on the frame can be adjusted to provide a gap therebeneath of between 1 cm and 6 cm.

13. A dark brooder according to claim 4, wherein the relative height of the wall portions on the frame can be adjusted to provide a gap therebeneath of between 1 cm and 6 cm.

15. A dark brooder according to claim 5, wherein the relative height of the wall portions on the frame can be adjusted to provide a gap therebeneath of between 1 cm and 6 cm.

16. A dark brooder according to claim 2, wherein the lid section comprises a conductive material and an infra-red heater is provided that can heat the lid section.

17. A dark brooder according to claim 3, wherein the lid section comprises a conductive material and an infra-red heater is provided that can heat the lid section.

18. A dark brooder according to claim 4, wherein the lid section comprises a conductive material and an infra-red heater is provided that can heat the lid section.

19. A dark brooder according to claim 5, wherein the lid section comprises a conductive material and an infra-red heater is provided that can heat the lid section.

20. A dark brooder according to claim 6, wherein the lid section comprises a conductive material and an infra-red heater is provided that can heat the lid section.
